(19) United States
(12) Patent Application Publication
(10) Pub. No.: US 2007/0105970 A1
(43) Pub. Date: May 10, 2007

(54) Energy absorbing flexible foam

(76) Inventors: Kenneth Warnshuis, Adrian, MI (US); Felipe R. Terrones, Adrian, MI (US); Victor Gandara, Adrian, MI (US)

Correspondence Address: Miller, Canfield, Paddock and Stone P.L.C;c/o Robert Kelley Roth, Suite 2500, 150 West Jefferson Ave, Detroit, MI, 48226, US

(21) Appl. No.: 11/495,795

(22) Filed: Jul. 28, 2006

Related U.S. Application Data
(63) Continuation-in-part of application No. 11/272,358, filed on Nov. 10, 2005.

(51) Int. Cl. C08J 9/16

(52) U.S. Cl. 521/56

(57) ABSTRACT

An energy absorbing foam capable of passing FMVSS 202A, parts 2.6 and 2.7 and a method of manufacturing such foam are disclosed. Such energy absorbing foams are produced by combining, preferably in a mold, a polyol component with an isocyanate component at an NCO Index of from about 10 to about 120. Expandable beads are included in the foam-forming mixture in an amount of from about 10 to about 150 parts by weight, per 100 parts by weight of the polyol component. The polyol component and the isocyanate component react exothermically to form a flexible foam, and heat generated from the reaction causes the expandable beads to at least partially expand, but the mold is at a temperature below that where significant expansion of the expandable beads occurs.

### RELATED APPLICATION

This application is a continuation-in-part which claims priority benefit of U.S. utility patent application No. 11/272,358 filed on Nov. 10, 2005.

### FIELD OF THE INVENTION

This invention relates to energy absorbing flexible foams, and more particularly to energy absorbing flexible polyurethane foams suitable for use in the production of foam headrests which satisfy the requirements of Federal Motor Vehicle Safety Standard (“FMVSS”) 202A.

### BACKGROUND OF THE INVENTION

Flexible foam objects are used in many cushioning applications, including furniture, bedding, steering wheels, instrument panels, console box lids and glove box lids, seating, carpet underlays, armrests and headrests, etc. Flexible foams comprise a range of foams, including integral skin foams, slab stock (used extensively in furniture foams and bedding), molded flexible foams, and viscoelastic foams (used in bedding, pillows and some automotive foam applications). Generally these foams are not structural members and they resiliently yield to pressure.

Flexible polyurethane foams can be formed from a reaction of a polyol mixture and an isocyanate. A broad range of properties and characteristics have been made for polyurethanes (from rigid polyurethane foams to flexible polyurethane foams) principally by varying components of the polyol mixture and the foaming equipment used. For flexible polyurethane foams, long chain triols and water may be used as components of the polyol mixture. A wide variety of isocyanates can be used to make flexible polyurethane foam, but the most common isocyanates are toluene diisocyanate (TDI) and polymeric isocyanate (MDI). When the aforementioned polyol mixtures are reacted with the aforementioned isocyanates, wide-meshed elastic networks of ruptured cell walls are formed, creating a web of elastic strands.

Alternate polyol mixtures are used to create rigid polyurethane foams. These typically include branched starting materials such as low molecular weight alcohols with three or more reactive centers (OH groups). Rigid polyurethane foams have a high density of covalent cross-linking, and a high hydroxyl value range (used as a measure of the concentration of isocyanate-reactive hydroxyl groups per unit weight of the polyol). Rigid polyurethane foams have a closed cell structure with discrete foam cells separated from each other by a polymer matrix. Rigid foams are typically not used where a cushioning material is desired. By contrast, flexible polyurethane foams generally have an open cell structure, wherein the cell wall membranes rupture and leave polymer material struts which form a web of elastic strands.

Several patents discuss use of expandable polymer materials mixed with polyurethanes. U.S. Pat. No. 3,277,026 to Newnham et al discloses an upholstery foam material comprising latex rubber or polyurethane (rigid or flexible) with polystryrene granules. This foam material is made in an open mold or paper mold, and produces a material having uniform density. U.S. Pat. No. 3,503,840 to Parrish discloses a cushioning structure especially useful as a carpet underlay comprising a resilient open-celled foam and gas-inflated organic polymeric cellular material formed in an open mold and to provide a structure with an overall low density. U.S. Pat. No. 3,607,797 to Rubens discloses a composite low density flexible foam comprising a flexible polyurethane and a polyvinyl aromatic hydrocarbon formed in a paperboard box mold.

U.S. Pat. No. 6,727,290 to Roth discloses a rigid polyurethane formed from a mixture of a polyol and an isocyanate. A small amount of expandable beads are added to the mixture before it cures. The beads expand and take up some of the space which would otherwise be occupied with polyurethane. However, such rigid polyurethanes have structural properties where they are designed to withstand relatively large amounts of loading (e.g., rigid polyurethanes may be used as plastic pallets). To maintain these properties, rigid foams require relatively large amounts of isocyanates and relatively low amounts of beads, to preserve density and maintain rigid foam impact durability. Further, with rigid polyurethane foams containing expandable beads as disclosed in Roth et al, gas released from the beads is trapped by a rigid polyurethane matrix and forms a bubble. The beads partial melt due to relatively high heat of reaction and form a coating around the bubble. The bubble acts to keep the rigid polyurethane density low and to enhance impact resistance. None of these disclosures, however, teaches an energy absorbing, flexible polyurethane foam which satisfies the requirements of FMVSS 202A.

Flexible polyurethane foams may be used in headrests, and have been used in production in motor vehicles for many years. The flexible foam headrest provides both a convenient place to rest an operator's head and also provides protection in the event of sudden changes in acceleration of the motor vehicle. Headrests also often are adjustably mounted to a seat to provide comfort adjustment. Generally, such headrests include cloth covered headrests and integral skin foam headrests. With cloth covered headrests, a flexible foam or cushion like interior is shrouded by a cloth. Integral skin foam headrests have a thin exterior integral skin region (often made with a urethane paint applied to a mold surface) and an interior region having a high degree of foaming. Known flexible foam headrests are subject to competing design constraints. On the one hand it is desirable to make the foam headrest comfortable for the occupant. On the other hand it is desirable to increase the stiffness of the headrest to reduce a whiplash effect during sudden changes in acceleration of a motor vehicle. It would be highly desirable to provide a flexible foam material which absorbs energy due to changes in acceleration of a vehicle and has the stiffness characteristics needed for head support during normal operation of the vehicle.

### SUMMARY OF THE INVENTION

It has been found that an energy absorbing, flexible polyurethane foam which is suitable for the production of a headrest satisfying the requirements of FMVSS 202A is obtained by reacting a polyol component which includes at least one polyether polyol having a functionality of from 2 to 4 and a hydroxyl number of from about 20 to about 100 with an isocyanate component and expandable beads which may be filled with a material which acts as a blowing agent under the foam-forming conditions. The polyol component and the isocyanate component react exothermically and heat generated from the reaction causes the expandable beads to at least partially expand. The mold into which the foam forming mixture is deposited is maintained at a temperature below that at which significant expansion of the expandable beads occurs. The density of the molded foam article produced in accordance with this invention is not uniform throughout the molded article. In one embodiment of the invention, the edges of the molded article are heated to a temperature below that at which significant expansion of the expandable beads occurs.

From the foregoing disclosure and the following more detailed description of various preferred embodiments it will be apparent to those skilled in the art that the present invention provides a significant advance in the technology of energy absorbing, flexible polyurethane foam parts such as headrests. Particularly significant in this regard is the potential the invention affords for providing a high quality flexible energy absorbing foam part with varying density which is capable of satisfying the requirements of FMVSS 202A. Additional features and advantages of various preferred embodiments will be better understood in view of the detailed description provided below.

### BRIEF DESCRIPTION OF THE DRAWINGS

FIG. 1 is a perspective view of a mold halves suitable for making a molded foam article in accordance with a preferred embodiment.

FIG. 2 is a perspective view of a cloth covered headrest formed from a molded foam in accordance with a preferred embodiment.

FIG. 3 is a perspective view of an integral skin headrest formed from a molded foam in accordance with a preferred embodiment.

FIG. 4 is a cross section view of the headrest of FIG. 3, showing the varying density of the foam material.

FIG. 5 is a view of a headrest assembled to a motor vehicle seat being subjected to a vertical load.

FIG. 6 is a graph showing load vs. displacement for a headrest subject to vertical load.

FIG. 7 is a view of a headrest assembled to a motor vehicle seat being subjected to an offset load.

FIG. 8 is a graph showing load vs. displacement for a headrest subject to an offset load.

It should be understood that the appended drawings are not necessarily to scale, presenting a somewhat simplified representation of various preferred features illustrative of the basic principles of the invention. The specific design features of the energy absorbing flexible foam of the present invention will be determined in part by the particular intended application and use environment. Certain features of the illustrated embodiments have been enlarged or distorted relative to others to help visualization and clear understanding. In particular, thin features may be thickened, for example, for clarity of illustration. All references to direction and position, unless otherwise indicated, refer to the orientation illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the flexible energy absorbing foams disclosed here. The following detailed discussion of various alternative and preferred features and embodiments will illustrate the general principles of the invention with reference to a headrest suitable for use in automotive applications. Other embodiments suitable for other applications will be readily apparent to those skilled in the art given the benefit of this disclosure.

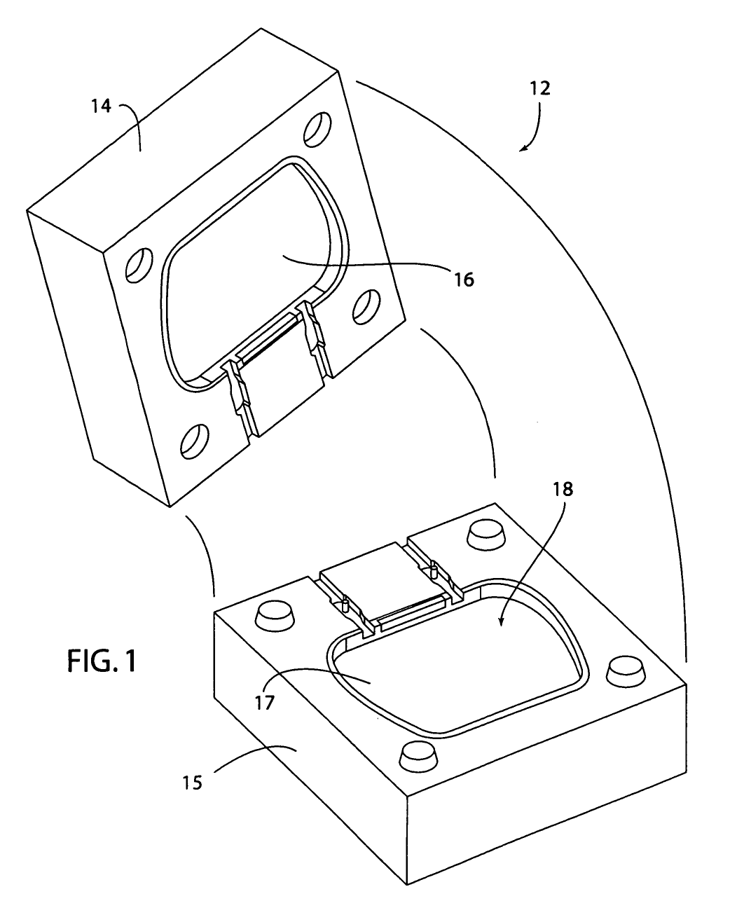

Broadly, manufacture of a flexible polyurethane foam part involves combining a polyisocyanate component and an isocyanate-reactive component to form a foam-forming mixture and depositing the foam forming mixture in a mold before foam formation is completed. The flexible foam parts produced in this manner can be used as automotive headrests, for bedding and other furniture applications, for pillows or seat cushioning, other consumer and automotive foam products. FIG. 1 shows a representative example of an open mold 12 adapted to receive the foam forming mixture. The halves 14, 15 of the mold 12 have corresponding mold surfaces 16, 17 which can be closed together and cooperate to define a mold cavity 18 which corresponds to the shape of the part to be molded, here, an automotive headrest 10. A cured polyurethane foam part is formed by reaction of two components: an isocyanate-reactive component which preferably includes at least one polyether polyol with a functionality of from 2 to 4, preferably about 3, a hydroxyl number of from 20 to about 100, preferably, from about 20 to about 60 and, preferably, a primary OH content such that average primary OH content of the isocyanate-reactive component (also referred to herein as the “polyol component”) is at least 50%, more preferably, at least 70%, and an isocyanate component comprising at least one isocyanate having an isocyanate functionality of at least 2. The isocyanate and isocyanate-reactive components are generally combined to form a foam-forming mixture before being introduced into the mold cavity 18, but the individual components may also be combined as they are simultaneously introduced into the mold cavity 18. The isocyanate and isocyanate-reactive components react exothermically and quickly foam to fill the mold cavity 18. A frame 12, often a metal frame, is used which operatively connects the headrest to a motor vehicle seat assembly. The frame is surrounded by the foam.

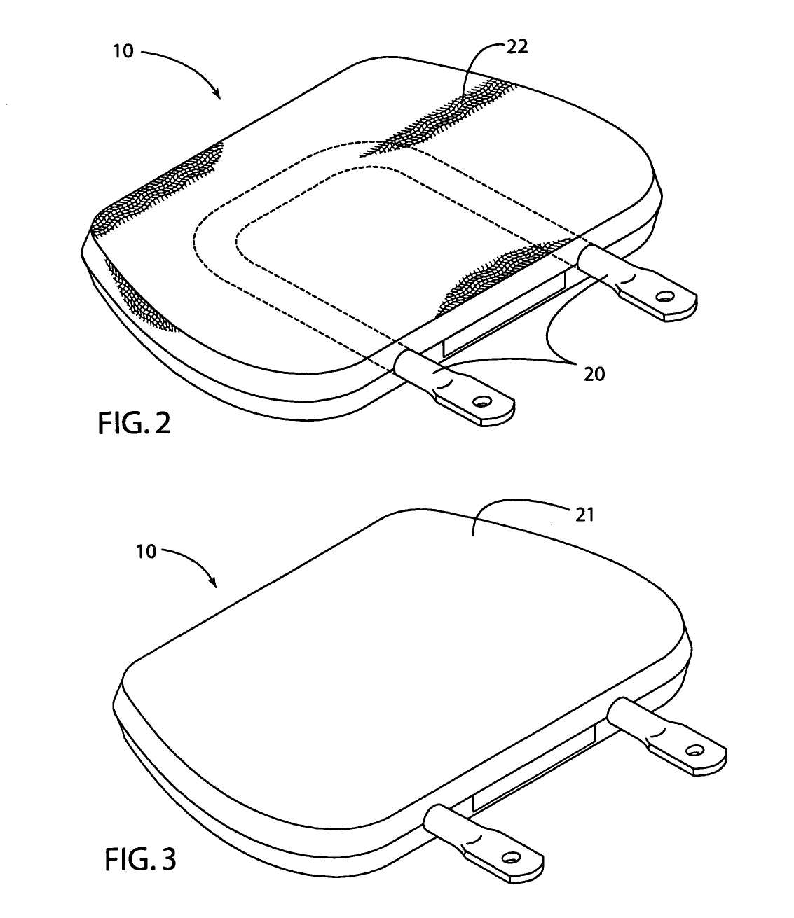

The headrest 10 may be formed with a cloth, fabric or leather covering 14 as shown in FIG. 2. The covering may be assembled after the foam is cured, or before, as would be the case with a pour-in-place mold. Optionally, a urethane paint 21 may be applied to the mold prior to introducing the foam-forming mixture or components into the mold. The polyol component and isocyanate component react behind the paint to form an integral skin foam part as shown in FIG. 3.

Typically the polyol component comprises at least one polyether polyol having a hydroxyl functionality of from 2 to 4 and a hydroxyl number of from about 20 to about 100, a surfactant (to help reduce surface tension of the fluid), a catalyst (to accelerate the reaction) and optionally, water and/or a blowing agent. The polyol component may also include any of the other known polyols, polyamines, graft copolymer polyols, cell openers, cross-linkers, fillers, colorants, flame retardants, plasticizers, bacteriostats, UV stabilizers, antistatic agents.

Examples of other suitable organic materials containing hydroxyl groups include polyols such as polyester polyols, polyether polyols having functionalities greater than 4 and polyether polyols having hydroxyl numbers greater than 100, polyhydroxy polycarbonates, polyhydroxy polyacetals, polyhydroxy polyacrylates, polyhydroxy polyester amides and polyhydroxy polythioethers. Polyester polyols, polyether polyols and polyhydroxy polycarbonates are preferred.

Suitable polyester polyols include the reaction products of polyhydric alcohols (preferably dihydric alcohols to which trihydric alcohols may be added) and polybasic (preferably dibasic) carboxylic acids. In addition to these polycarboxylic acids, corresponding carboxylic acid anhydrides or polycarboxylic acid esters of lower alcohols or mixtures thereof may also be used to prepare the polyester polyols useful in the practice of the present invention. The polycarboxylic acids may be aliphatic, cycloaliphatic, aromatic and/or heterocyclic and they may be substituted, e.g. by halogen atoms, and/or unsaturated. Examples of suitable polycarboxylic acids include: succinic acid; adipic acid; suberic acid; azelaic acid; sebacic acid; phthalic acid; isophthalic acid; trimellitic acid; phthalic acid anhydride; tetrahydrophthalic acid anhydride; hexahydrophthalic acid anhydride; tetrachlorophthalic acid anhydride, endomethylene tetrahydrophthalic acid anhydride; glutaric acid anhydride; maleic acid; maleic acid anhydride; fumaric acid; dimeric and trimeric fatty acids such as oleic acid, which may be mixed with monomeric fatty acids; dimethyl terephthalates and bis-glycol terephthalate. Suitable polyhydric alcohols include: ethylene glycol; 1,2- and 1,3-propylene glycol; 1,3- and 1,4-butylene glycol; 1,6-hexanediol; 1,8- octanediol; neopentyl glycol; cyclohexanedimethanol; (1,4-bis(hydroxymethyl)cyclohexane); 2-methyl-1,3-propanediol; 2,2,4-trimethyl-1,3-pentanediol; triethylene glycol; tetraethylene glycol; polyethylene glycol; dipropylene glycol; polypropylene glycol; dibutylene glycol and polybutylene glycol, glycerine and trimethylolpropane. The polyesters may also contain a portion of carboxyl end groups. Polyesters of lactones, e.g. caprolactone or hydroxyl carboxylic acids such as ω-hydroxycaproic acid, may also be used.

Suitable polycarbonates containing hydroxyl groups include those obtained by reacting diols with phosgene, a diarlycarbonate (e.g., diphenyl carbonate) or cyclic carbonates (e.g., ethylene or propylene carbonate). Examples of suitable diols include: 1,3-propanediol; 1,4-butanediol; 1,6- hexanediol; diethylene glycol; triethylene glycol; and tetraethylene glycol. Polyester carbonates obtained by reacting polyesters or polylactones (such as those described above) with phosgene, diaryl carbonates or cyclic carbonates may also be used in the practice of the present invention.

Polyether polyols include those obtained in known manner by reacting one or more starting compounds which contain reactive hydrogen atoms with alkylene oxides such as ethylene oxide, propylene oxide, butylene oxide, styrene oxide, tetrahydrofuran, epichlorohydrin or mixtures of these alkylene oxides. Suitable starting compounds containing reactive hydrogen atoms include polyhydric alcohols (described above as being suitable for preparing polyester polyols); water; methanol; ethanol; 1,2,6-hexane triol; 1,2,4-butane triol; trimethylol ethane; pentaerythritol; mannitol; sorbitol; methyl glycoside; sucrose; phenol; isononyl phenol; resorcinol; hydroquinone; and 1,1,1- or 1,1,2-tris-(hydroxyl phenyl )-ethane. Also vegetable based polyols, such as soy-based polyols, may be used.

Polyethers modified by vinyl polymers are also suitable. Such modified polyethers may be obtained, for example, by polymerizing styrene and acrylonitrile in the presence of a polyether (U.S. Pat. Nos. 3,383,351; 3,304,273; 3,523,095; 3,110,695 and German Patent No. 1,152,536).

The polythioethers useful in the present invention include the condensation products obtained from thiodiglycol on its own and/or with other glycols, dicarboxylic acids, formaldehyde, aminocarboxylic acids or amino alcohols. These condensation products may be polythio-mixed ethers, polythioether esters or polythioether ester amides, depending on the co-components.

Amine-terminated polyethers useful in the present invention may be prepared by reacting a primary amine with a polyether containing terminal leaving groups such as halides, or mesylates as disclosed in U.S. Pat. Nos. 3,666,726, 3,691,112 and 5,066,824.

Suitable polyacetals include those prepared from aldehydes (e.g., formaldehyde) and glycols such as diethylene glycol, triethylene glycol, ethoxylated 4,4′-dihydroxydiphenyldimethylmethane, and 1,6-hexanediol. Polyacetals prepared by the polymerization of cyclic acetals may also be used in the practice of the present invention.

Polyhydroxy polyester amides and polyamines useful in the present invention include the predominantly linear condensates obtained from polybasic saturated and unsaturated carboxylic acids or their anhydrides and polyvalent saturated or unsaturated aminoalcohols, diamines, polyamines and mixtures thereof.

Suitable monomers for producing hydroxy-functional polyacrylates include acrylic acid, methacrylic acid, crotonic acid, maleic anhydride, 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, glycidyl acrylate, glycidyl methacrylate, 2-isocyanatoethyl acrylate and 2-isocyanatoethyl methacrylate.

Any of the known surfactants, catalysts, blowing agents, cell openers, crosslinking agents, fillers, coloring agents, flame retardants, plasticizers, bacteriostatic agents, UV stabilizers, and anti-static agents may be included in the polyol component. Water is the most preferred blowing agent. A polyurethane reaction promoting catalyst is preferably included in the polyol component in an amount of from about 0.2 to about 5% by weight, based on total weight of polyol component.

The polyol component can be formed as a single mixture. Alternatively, as is the case with some slab stock materials and seating applications, some of the materials to be included in the polyol mixture may be formed as a slurry and metered in a separate stream. Other materials suitable for inclusion in the polyol component will be readily apparent to those skilled in the art given the benefit of this disclosure.

Any of the known organic isocyanates, modified isocyanates or isocyanate-terminated prepolymers made from any of the known organic isocyanates may be included in the isocyanate component of the present invention. Suitable isocyanates include aromatic, aliphatic, and cycloaliphatic polyisocyanates and combinations thereof. Useful isocyanates include: diisocyanates such as m-phenylene diisocyanate, p-phenylene diisocyanate, 2,4-toluene diisocyanate, 2,6-toluene diisocyanate, 1,6-hexamethylene diisocyanate, 1,4-hexamethylene diisocyanate, 1,3-cyclohexane diisocyanate, 1,4-cyclohexane diisocyanate, hexahydrotoluene diisocyanate and its isomers, isophorone diisocyanate, dicyclohexylmethane diisocyanates, 1,5-naphthalene diisocyanate, 1-methylphenyl-2,4-phenyl diisocyanate, 4,4′-diphenylmethane diisocyanate, 2,4′-diphenylmethane diisocyanate, 4,4′-biphenylene diisocyanate, 3,3′-dimethoxy-4,4′-biphenylene diisocyanate and 3,3′-dimethyl-4,4′-biphenylene diisocyanate; triisocyanates such as 2,4,6-toluene triisocyanate; and polyisocyanates such as 4,4′-dimethyl-diphenylmethane-2,2′,5,5′-tetraisocyanate and the polymethylene polyphenylpolyisocyanates.

Undistilled or crude polyisocyanate may also be used. The crude toluene diisocyanate obtained by phosgenating a mixture of toluene diamines and the diphenylmethane diisocyanate obtained by phosgenating crude diphenylmethanediamine (polymeric MDI) are examples of suitable crude polyisocyanates. Suitable undistilled or crude polyisocyanates are disclosed in U.S. Pat. No. 3,215,652.

Modified isocyanates are obtained by chemical reaction of diisocyanates and/or polyisocyanates. Modified isocyanates useful in the practice of the present invention include isocyanates containing ester groups, urea groups, biuret groups, allophanate groups, carbodiimide groups, isocyanurate groups, uretdione groups and/or urethane groups. Preferred examples of modified isocyanates include prepolymers containing NCO groups and having an NCO content of from about 25 to about 35% by weight, preferably from about 28 to about 32% by weight. Prepolymers based on polyether polyols or polyester polyols and diphenylmethane diisocyanate are particularly preferred. Processes for the production of these prepolymers are known in the art.

Mixtures of any of the known isocyanates may also be used. Mixtures of methylene diphenyl polyisocyanate and toluene diisocyanate are particularly preferred.

Typically the isocyanate component comprises an isocyanate such as TDI or MDI. For flexible foam polyurethanes, if 100 parts by weight of polyol component are used, then typically 20-100 parts by weight of the isocyanate component are used. In the production of the headrests of the present invention, the isocyanate and polyol components are reacted in amounts such that the NCO index ranges from about 60 to about 120. Use of the term “NCO Index” in a table of formulations indicates the appropriate amount of isocyanate that should be used in order to achieve a formulation having the indicated NCO index.

The energy-absorbing foam of the present invention is formed by including expandable beads in the foam-forming mixture. As the foam-forming reaction takes place, heat is generated, typically in the range of about 205-265° F., most typically about 225° F. near the center. This heat causes gas trapped in the expandable beads to be released, expanding the volume of the bead. However, in accordance with a highly advantageous embodiment of the invention, the foam-forming mixture is introduced into a mold cavity which is cooler near its edges. Depending upon their composition, the expandable polymer beads typically start to significantly expand around 180-220° F., for example, 200° F. Significant expansion as used herein means greater than 20% expansion over the size of the expandable beads at ambient conditions, or about 70° F. Typically expansion of the expandable beads follows a generally sigmoidal curve with temperature increase. Preferably the mold is only heated to a temperature less than the temperature at which the expandable beads begin significant expansion, about 110-170° F., most typically about 140° F. Some heating of the mold is preferred to ensure good properties (such as complete reaction of the polyol mixture and the isocyanate).

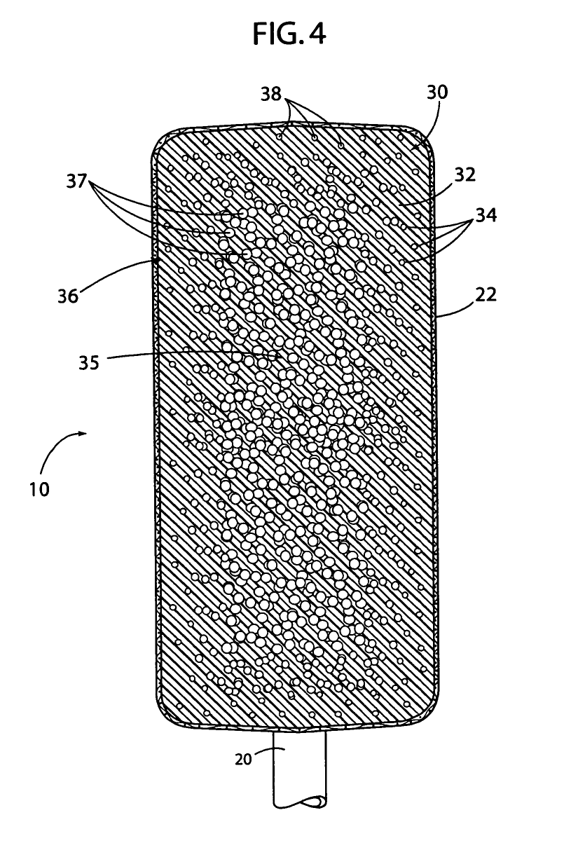

Controlling the temperature of the mold helps regulate the degree of bead expansion and helps to determine the depth of the edge layer of the foam article. Heating the mold also helps to ensure acceptable surface characteristics in the finished part. A cross section through such a part generally shows a matrix of cured polyurethane foam with large beads in the center and smaller, less expanded beads around the periphery or edge of the part. FIG. 4 shows the result when the multi-density foam material is used to form a headrest 10. The foam article 30 comprises polyurethane foam 32 and expandable beads 34. The beads 37 in the center 35 have expanded the most, and the beads 38 at the edge 36 have expanded the least. As the beads (even the expanded beads) are denser than the polyurethane foam, the effect is to create a part having a first density in the center 35 and a second density less than the first density at the edge 36. When the part is a headrest, the effect is a soft exterior which is comfortable and which make its easier to attach a covering. A harder interior which helps reduce the chances of whiplash in some instances and can help pass stringent automotive seat regulations, such as FMVSS 202A, parts 2.6 and 2.7. Parts made with the current invention typically have an Indentation Force Deflection (IFD), which is a measure of the load bearing capacity of flexible polyurethane foam which is greater near the center of the part than at the edge. IFD is generally measured as the force (in pounds or Newtons) required to compress a 50 square inch circular indentor foot into a four inch thick sample no smaller than 15 inches square, to a stated percentage of the sample's initial height. Common IFD values for flexible foam polyurethane parts are generated at 25 and 65 percent of initial height.

Materials that are suitable for use as the expandable beads in the foam-forming compositions of the present invention include unexpanded and partially expanded thermoplastic polymers such as polypropylenes, polyolefins, polystyrenes, polyethylenes, and combinations thereof. Other materials suitable for use as expandable beads will be readily apparent to those skilled in the art given the benefit of this disclosure.

Preferably, the unexpanded expandable beads have a diameter of from about 0.1 to 6 mm, most preferably about 0.8 mm. Also, it has been found use of such expandable beads in an amount of from about 10 to about 150 parts by weight per 100 parts by weight of the total polyol component is particularly advantageous. Use of such an amount of beads has been found to create multi-density cured polyurethane foams. In a particularly preferred embodiment of the present invention, polystyrene beads are included in an amount of from 20 to 100 parts by weight per 100 parts by weight of polyol component.

Other two component polyol/isocyanate mixtures which work with the expandable beads discussed herein will be readily apparent to those skilled in the art given the benefit of this disclosure. For example, a suitable viscoelastic foam used to make seat cushions and automotive parts which can incorporate expandable polymeric beads is the system which is commercially available under the name Bayfit 582 from Bayer MaterialScience.

Because the reaction between the polyol component and the isocyanate component is fairly rapid, it is preferred that the expandable beads be premixed with either the polyol component or the isocyanate component, or both. Sometimes it is advantageous to add the beads to both of the foam-forming components to aid in the processing of the foam. For example, half of the total amount of beads to be used may be added to the polyol component and the other half of the beads may be added to the isocyanate component.

EXAMPLE 1

An integral skin foam flexible polyurethane part can be made by applying a commercially available polyurethane paint (free of expandable polymeric beads) to a mold, and then injecting two reactants; the first reactant is 100 parts by weight of a polyol component (comprising largely a polyol) and 50 parts by weight of polypropylene beads average diameter of the unexpanded bead was 0.8 mm. The second reactant was an isocyanate component, comprising largely an isocyanate, in an amount of 40 parts by weight. Typically little or no water is used for such integral skin flexible foam parts. Water substitutes may be used as a blowing agent, e.g., ethylene glycol, carbamides, and other commercially available blowing agents, if needed. The polyols and isocyanates can be supplied as system (where one supplier provides a premixed polyol component containing polyol and some other ingredients, and separately a premixed isocyanate component, most typically comprising largely isocyanate) which may be available from any one of numerous sources, including the Bayflex system which is commercially available from Bayer MaterialScience. Although 50 parts by weight of beads is most preferred, smaller amounts such as 10-20 parts have also been found to produce acceptable energy absorbing foam parts.

EXAMPLE 2

A flexible foam polyurethane part without an integral skin is formed by combining a first component and a second component. The first component comprises 100 parts by weight of a polyol mixture, 4.5 parts by weight water, mixed with 100 parts by weight polypropylene beads, average diameter (unexpanded) of about 0.8 mm. The second component comprises about 75 parts by weight of an isocyanate mixture. The second component is mixed with the first component in a mold. The reaction is exothermic and foam generating, and causes the foam to expand (both polyurethane and expandable beads) to fill the mold. Suitable polyol components and isocyanate components include those which are commercially available the Bayfit system (available from Bayer MaterialScience) or the Rubiflex/Rubinate system (supplied by Huntsman). The polyol component and isocyanate component may be blended together at the site of production of the foam part.

### EXAMPLE 3

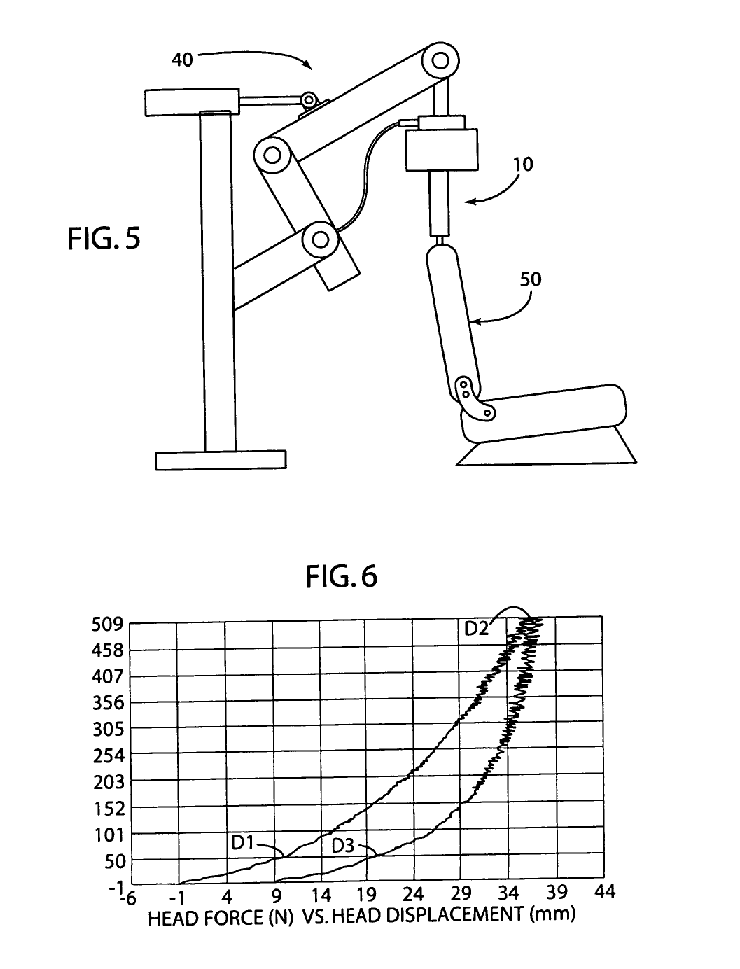

Automotive headrests made using the multi-density flexible foam disclosed herein are advantageous in that they can pass newer, more stringent tests designed to simulate a head or other object hitting a headrest and a rear impact in a motor vehicle, such as FMVSS 202A Section 5.2.6 (for height retention) and Section 5.2.7 (backset retention, strength and displacement). FIG. 5 shows a simplified schematic of a test fixture 40 designed to apply a load to a headrest 10 affixed to a motor vehicle seat assembly 50. As shown, the fixture is set for the height retention test. The multi-density foam material comprises 100 pts of a polyol component, 55 parts by weight polystyrene beads and 41 parts by weight isocyanate component. The polyol component used is commercially available from Bayer MaterialScience under the name Bayfit 601B and the isocyanate component used is commercially available from Bayer MaterialScience under the name Bayfit 601A.

In the height retention test, the headrest begins in an uncompressed position, and is subjected to a load simulating hitting the headrest, comprising gradually applying a vertical load straight down from the headrest toward the seat assembly as shown in FIG. 5, deflecting and compressing the headrest at the point of contact. When the load reached 50 N, the amount of deflection was measured as D1=10.4 mm. Deflection reflects the amount the headrest is compressed by the load. This D1 measurement is significantly less than the maximum allowable test specification deflection of D1 less than 25 mm. The load is held for 5 seconds, then the test fixture continues to increase the load until it reaches 500 N, is again held for 5 seconds (where the deflection D2 is measured), and then gradually reduces the load until it returns to 50 N. The deflection D3 is measured. The difference between the deflection at this instant D3 and the D1 deflection, or height retention was 9.7 mm, again significantly less than the test specification of less than 13 mm. FIG. 6 shows a graph of loading vs. displacement during this cycle. The entire test takes about 250 seconds.

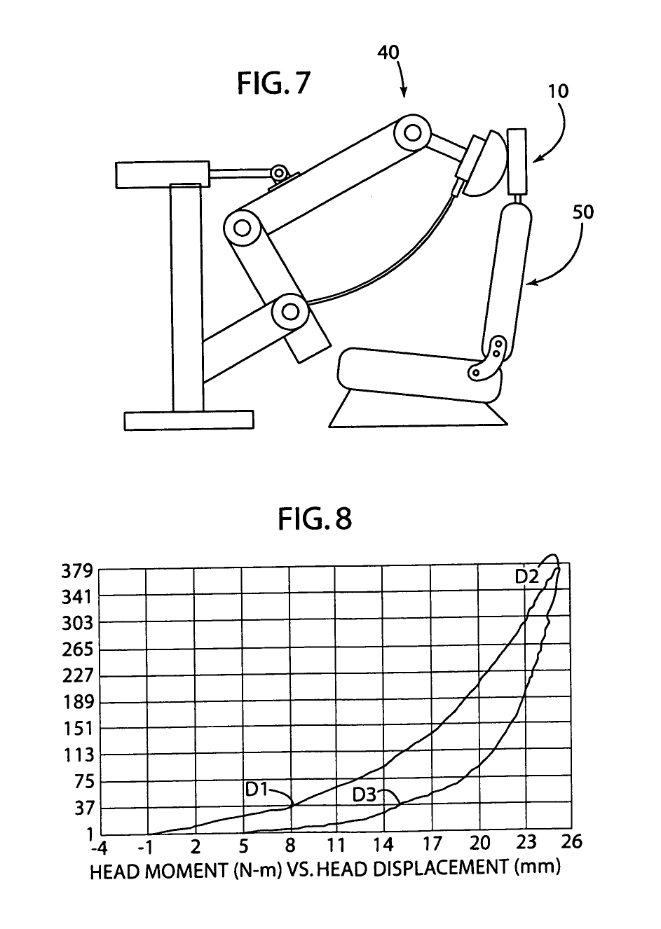

FIG. 7 shows the test fixture 40 applying a load at an angle with respect to the headrest 10, generating a moment on the headrest and on the seat assembly 50 to which it is attached. As shown, the test fixture is set for the backset retention, strength and displacement test, and the angle is about 25 degrees between vertical and a torso reference line. Vertical is understood here to refer to the upward direction with reference to the seat assembly. The precise angle varies somewhat depending on the size of the seat assembly and the seat's H-point (distance between the hip and the ground or floor), but is generally 20-30 degrees from vertical. The headrest comprises the same material as was used in the height retention test. Load is gradually applied until a torso moment of 37 N-m (50 N direct loading) is reached, and deflection of the headrest D1 is measured as 8.2 mm. This is significantly less than the maximum allowable test specification deflection of D1 less than 25 mm. The test fixture continues to increase the torso moment until it reaches 373 N-m (500 N direct loading), the deflection D2 is measured, and then gradually reduces the load until it returns to 37 N-m. The deflection D3 is again measured. The difference between the deflection at this instant D3 and the D1 deflection, or backset retention was 7.2 mm, again significantly less than the test specification of less than 13 mm. FIG. 8 shows a graph of torque loading vs. displacement in this test cycle. As with the height retention test, the load is held for 5 seconds at the initial torso moment, and again held for 5 seconds at the maximum torso moment. The entire test takes about 250 seconds.

The results of these two tests are significant. The new foam material disclosed herein used for a headrest allows the headrest to pass these two tests without relatively expensive modifications, such as modifying the frame or the seat assembly or the addition of a stiff inner filler.

The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A process for the production of an energy absorbing foam capable of passing FMVSS 202A, parts 2.6 and 2.7, comprising, in combination, the step of reacting a foam-forming composition comprising:
a) an isocyanate component comprising:
1) at least one organic diisocyanate or polyisocyanate,
b) an isocyanate-reactive component comprising:
1) at least one polyether polyol having a hydroxyl group functionality of from 2 to 4 and an OH number of from about 20 to about 100,
2) a blowing agent, and
3) a catalyst, and
c) expandable thermoplastic beads.

2. The process of claim 1 wherein the expandable thermoplastic beads are included in the isocyanate-reactive component.

3. The process of claim 1 wherein the expandable thermoplastic beads are included in both the isocyanate component and the isocyanate-reactive component.

4. The process of claim 1 wherein a filled polyol is included in the isocyanate-reactive component.

5. The process of claim 1 wherein the blowing agent is water.

6. The process of claim 1 wherein the isocyanate component includes an isocyanate prepolymer.

7. The process of claim 1 wherein the isocyanate component includes both methylene diphenyl polyisocyanate and toluene diisocyanate.

8. The process of claim 1 wherein a surfactant is included in the isocyanate-reactive component.

9. The process of claim 1 wherein the isocyanate-reactive component has a primary OH content of at least 50%.

10. The process of claim 1 wherein the isocyanate-reactive component has a primary OH content of at least 70%.

11. The process of claim 1 wherein the thermoplastic expandable beads are selected from the group consisting of unexpanded and partially expanded beads of polypropylene, polyolefins, polystyrenes, polyethylenes and combinations thereof.

12. The process of claim 1 wherein the diameter of the thermoplastic expandable beads is from about 0.1 mm to 6 mm.

13. The process of claim 1 wherein the diameter of the thermoplastic expandable beads is about 0.8 mm.

14. The process of claim 1 wherein the thermoplastic expandable beads are polystyrene beads.

15. The process of claim 14 wherein the polystyrene beads are included in the isocyanate-reactive component in an amount from about 10 parts by weight to about 150 parts by weight, based on 100 parts by weight of the total isocyanate-reactive component.

16. The process of claim 1 wherein the isocyanate and isocyanate-reactive components are reacted at an NCO index of from about 60 to about 120.

17. An energy absorbing flexible foam which passes FMVSS 202A, parts 2.6 and 2.7 produced by the process of claim 1.

18. An energy absorbing flexible foam which passes FMVSS 202A, parts 2.6 and 2.7 produced by the process of claim 2.

19. A headrest produced from the foam of claim 17.

20. A headrest produced from the foam of claim 18.
